(19) United States
(12) Patent Application Publication
(10) Pub. No.: US 2007/0139525 A1
(43) Pub. Date: Jun. 21, 2007

(54) PRODUCING A VIDEO SIGNAL

(75) Inventor: David Richard AMPHLETT, Cassington, Oxfordshire (GB)

Correspondence Address: RICHARD M. GOLDBERG, 25 EAST SALEM STREET, SUITE 419, HACKENSACK, NJ, 07601, US

(73) Assignee: GEKKO TECHNOLOGY LIMITED, Kenilworth (GB)

(21) Appl. No.: 11/608,547

(22) Filed: Dec. 8, 2006

(30) Foreign Application Priority Data
Dec. 16, 2005 (GB) 05 25 626.8

(51) Int. Cl. H04N 5/225

(52) U.S. Cl. 348/207.99

(57) ABSTRACT

Video signals are produced from a scene lit at least partially by artificial light (404, 405). A video camera (401) captures video fields or frames of video at a capture rate such that a frame interval exists that relates exclusively to an individual field or frame. A camera includes a shuttering device such that light is received for capturing a portion of each frame interval. An energisation device is configured to energise a synchronised light source to provide at least part of the artificial light. The synchronised light source is synchronised to the shuttering device such that the synchronised light source is energised substantially during the capturing portion and is not energised for at least part of an idle portion that falls within the frame intervals but does not form part of the capturing portions.

### CROSS REFERENCE TO RELATED APPLICATIONS

This application claims priority from United Kingdom patent application number 0525626.8 filed on Dec. 16, 2005, the entire disclosure of which is incorporated herein by reference in its entirety.

### TECHNICAL FIELD

The present invention relates to producing a video signal from a scene lit (at least partially) by artificial light.

### BACKGROUND OF THE INVENTION

Problems exist in terms of providing lighting for the production of movies and in television studios. The application of light mat be intrusive to performing talent and may generated large quantities of unwanted heat. Furthermore the removal of such heat may create further demands for energy due to the presence of air conditioning systems.

### SUMMARY OF THE INVENTION

According to an aspect of the invention, there is provided a method of producing a video signal from a scene lit (at least partially) by artificial light, comprising the steps of capturing fields or frames of video at a capture rate such that a frame interval exists that relates exclusively to an individual field or frame, deploying a shuttering device such that light is received for a capturing portion of each frame interval, and energising a synchronised light source to provide at least a part of the artificial light, wherein the synchronised light source is synchronised to the shuttering device, such that the synchronised light source is energised substantially during the capturing portions and not energised for at least a part of an idle portion that falls within the frame intervals but not forming part of the capturing portions.

### BRIEF DESCRIPTION OF THE SEVERAL VIEWS OF THE DRAWINGS

FIG. 1 illustrates the adjustment of light intensity from an array of LEDs;

FIG. 2 illustrates video fields;

FIG. 3 shows an example of talent being recorded outdoors in bright ambient conditions; and

FIG. 4 illustrates a studio environment.

### DESCRIPTION OF THE BEST MODE FOR CARRYING OUT THE INVENTION

An arrangement for illuminating a scene (at least partially) using light emitting diodes (LEDs) is shown in European Design Registration No. 000 385 356. The system is further described in United Kingdom Patent Applications Nos. 05 07 068.5 and 05 07 045.3 and United States patent application Ser. Nos. 11/100,117 and 11/100,023. In the system disclosed, a ring of light emitting diodes may be attached to the lens of a video or film camera to provide additional illumination, particularly for close-up shots.

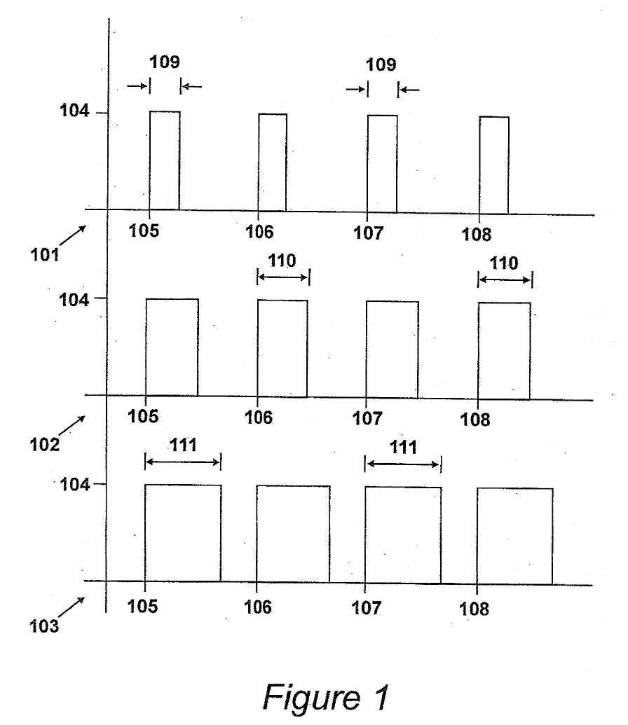

As shown in FIG. 1, light intensity from an array of LEDs is adjusted by adjusting the duration over which the LIED is energised for each cyclic duty cycle. Thus, as illustrated in FIG. 1, control is achieved via a process of pulse amplitude modulation. In each of the examples 101, 102, 103, a voltage intensity has a maximum value of 104, irrespective of the actual energy output, and therefore the perceived brightness. In the example, four duty cycles are shown with each cycle starting at a time 105, 106, 107 and 108. In 101, the LED array is energised for a relatively short duration 109. In example 102 the perceived brightness is increased (to approximately 50%) by energising the array for a duration 110. Furthermore, in example 103, the duration over which the LED array is illuminated is increased to a value 111 thereby again increasing the perceived brightness of the light emitted. However, at any instant, the LED is either fully illuminated or fully off.

It is appreciated that, currently, LED lighting systems are more expensive than tungsten lights for a give illumination. However, LED lighting systems are less affected by vibration and have a substantially longer life cycle, typically fifty thousand to one hundred thousand hours compared to one thousand to two thousand hours for a tungsten system. Thus, initial costs may be higher but ongoing maintenance costs may be substantially reduced. It is also appreciated that, over the next few years, LED lighting systems are destined to become less expensive and more efficient, such that they will be substantially less current drawn compared to tungsten systems for a give lighting output also resulting in a lower heating effect.

It is possible to provide pulsing control systems, possibly using thyristors, to a tungsten lighting system. However, the nature of the heating element results in an averaging effect, given that a substantial period of time is required for the element to heat and then subsequently cool down.

In LED lighting systems, the light emitted from the LEDs follows the pulses applied thereto and when analysed with appropriate equipment, the pulsing effect can be used. As an aside, this is the mechanism by which it is possible to transmit data using LEDs.

In a lighting environment for the production of video signals, the pulsing is not noticed by the eye due to the averaging effect of the eye. Thus, the pulsing is not seen and the lighting is perceived to be averaged and to be continuous over time, provided that the pulsing frequency is sufficiently high.

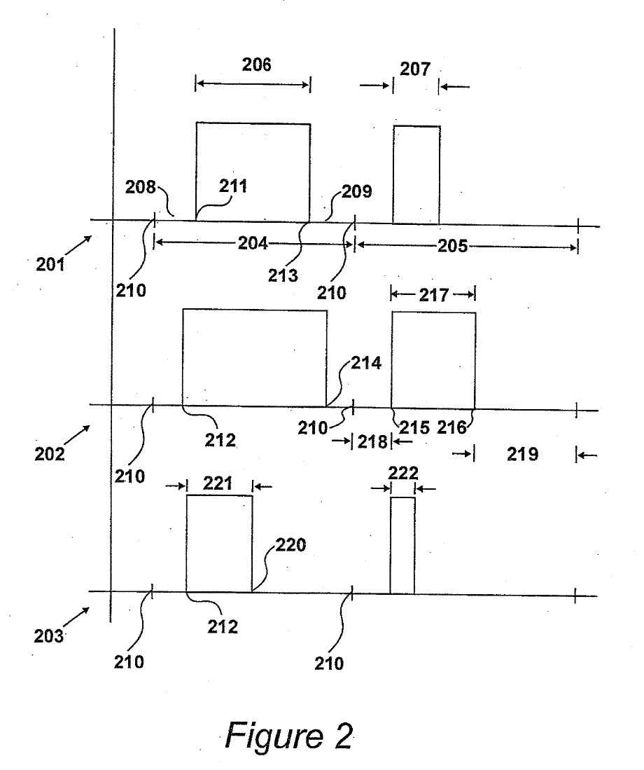

As is well known in the art, video fields are/or frames represent discreet portions of image data separated by blanking intervals. In FIG. 2, 202 represents two contiguous fields (or frames) of a video picture in which each image falls within a frame interval 204 and 205. At the beginning of the frame interval 104 and at the end of the frame interval 204 there is a video blanking period, primarily provided to ensure that a monitor synchronises with a video camera which, in video systems, results in the generation of the vertical blanking pulse. Furthermore, with sophisticated video equipment, it is possible to reduce the active image capturing duration by means of a shuttering device. Thus, in this example, within frame interval 204 a shuttering device is activated such that light is only received for a capturing portion 206. Upon the next frame duration 205, adjustments are made to the shuttering device such that the capturing portion is reduced to a duration 207, representing an even smaller duration within the whole of the frame interval 205.

It has been appreciated that the pulsing of the LED systems as illustrated in FIG. 1 represents a similar approach to the shuttering of light received by a camera, as illustrated at 201. The invention is therefore directed towards energising a synchronised light source to provide at least part of the artificial light. Thus, the synchronised light source is synchronised to the shuttering device, such that the synchronised light source is energised substantially during the capturing portions (206 and 207) and not energised for at least a part of an idle portion 208, 209 that falls within a frame interval 204 but does not form part of the capturing portions 206.

Thus, the overall approach is to energise the LED lighting systems substantially during regions 206 and 207 and to avoid energising the LED systems (which do not make any contribution to the resulting video signal) during portions 208 and 209. In this way, the output light energy is optimised such that light is only generated when the shutter is open. As a result, the perceived lighting input level received by the camera appears higher than when the lighting is viewed directly by a human observer.

An example of activation pulses supplied to an LED lighting system is illustrated at 202 and an alternative example is illustrated 203. Synchronisation pulses are generated at the start 210 of each frame interval 204, 205. In a multi-camera environment, all of the cameras are synchronised together (as is well known in the art) either by one of the cameras being established as a master, to which all of the others are slaved, or with all of the cameras receiving synchronised pulses from a central source; often referred to as “house synch”. In the present preferred embodiment, all or part of the lighting within a video recording environment is provided by LED systems. In addition, these systems are preferably configured to receive the synchronisation pulses such that the pulsing of the LED lights is brought into synchronism with the video cameras.

It is envisaged that, upon start-up, it may be necessary for the lighting synchronisation system to perform a training procedure in order to optimise the duration over which the LED systems are energised. This should not create an unnecessary burden, given that other calibration procedures will be performed in such an environment. One example of this would be ensuring that the cameras have been calibrated for colour balance.

In the example shown at 202, the lighting control systems for controlling the energisation of the LED lights receive the synchronisation pulses 210. A calibration circuit has determined that a video shutter opens at 211. To ensure that the image is illuminated throughout the capturing portion 206, the LED energising pulse is activated at 212, slightly before position 211. Similarly, deactivation of the shutter occurs at 213, after capturing portion 206 and again the de-energisation of the LED system is delayed slightly, such that deactivation occurs at 214, again ensuring that the scene is illuminated throughout the capturing portion.

On the next frame interval, the capturing duration 207 is substantially less than capturing duration 206. Consequently, the energising pulse is wider than the capturing interval 207 with energisation occurring at 215 and de-energisation occurring at 216. However, within the totality of the frame interval 205, the energisation interval 217 is reduced such that energy is not wasted over period 218 and over period 219.

In addition to being able to adjust the shutter speed, as illustrated when comparing frame interval 204 with frame interval 205, it is also possible to adjust lighting levels by adjusting the duration of the illuminating pulses. An adjustment of this type is illustrated at 203. In 203, a first illumination pulse occurs activated at 212; that is to say, activation in the example shown at 203 is the same as the activation shown at 202. However, the duration of the pulse is substantially less such that deactivation occurs at 220. Thus, in this example, a capturing portion for the shutter has a duration of 206, whereas the light energisation pulse has a duration 221. Similarly, for the next frame interval 205, the energisation pulse has a short duration 222 compared to the capturing interval 207.

In summary, the light emitting diode system may be energised for the whole of the video capturing interval, usually with a slight additional spread so as to ensure that the full capturing interval is illuminated. However, if the lighting level perceived by the camera is to be reduced, it is possible to reduce the energisation such that the LED systems are illuminated for portions that are shorter than the image capturing portions 206 and 207.

As is known in the art, shuttering devices typically operate at 24, 25, 30, 50 or 60 frames/fields per second, historically determined by the frequency of alternating current mains supplies.

In some embodiments the light sources may be physically mounted to the camera and in alternative embodiments the LED sources may be free standing lighting systems and LED lighting systems may be provided to light entire scenes. Thus, a plurality of light source energising devices may receive a synchronising pulse, such as house synch.

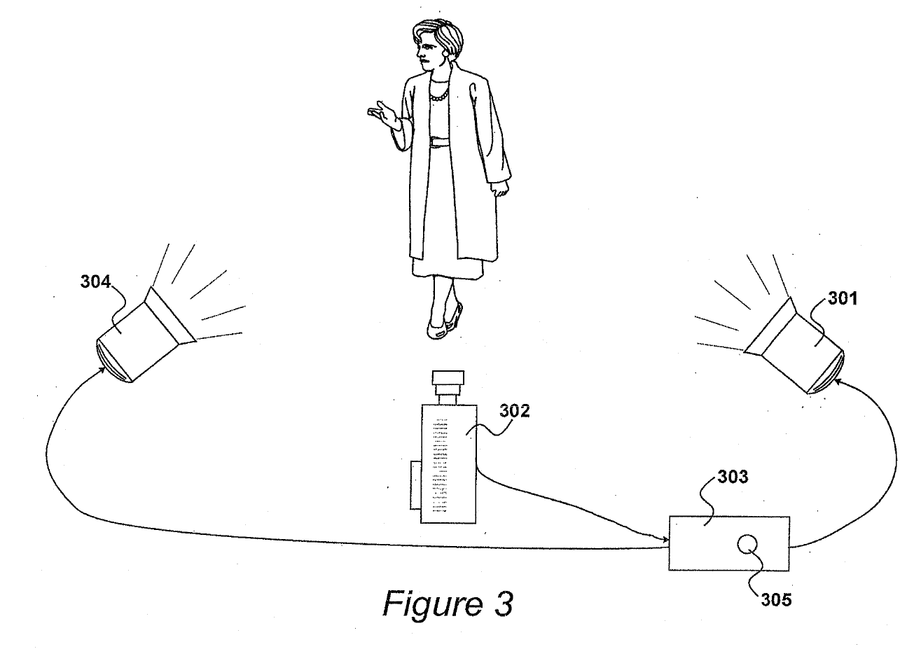

Figure 3 shows an example of talent being recorded outdoors in bright ambient conditions. Under these circumstances a fill light 301 is required to compensate for an over exposed or burnt out background. Thus, in order to achieve this, a strong light is required which can dazzle the talent or make it uncomfortable for the talent to function correctly.

By invoking a preferred embodiment of the present invention, it is possible for the LED based fill light 301 to be synchronised with a camera 303, such that the talent is effectively strobed in synchronisation with the camera shutter being open. Thus, this allows a greater output of light level to be directed towards the talent but for a shorter duration, thereby providing the necessary exposure level (for the short duration during which the camera shutter is open) rather than for a continuous duration which would dazzle the talent. Furthermore, as illustrated at 207, the duration of the lamp on time could be further reduced when used in conjunction with a fast shutter speed thereby further compounding the benefits of reduced power consumption and enhanced comfort.

In the example shown in FIG. 3, camera 302 generates master synch which is supplied to a control circuit 303. Control circuit 303 supplies the energising pulses to the fill light 301 and to a further light 304. Synchronisation circuit 303 is also provided with a control knob 305 so as to adjust the duration of the lighting pulses, as described with reference to 202 and 203. In this way, it is possible to allow interactive control of the duration of the light output by means of the synchronising pulse input signals derived from the video camera 302 or from a pulse generator. Furthermore, the generation of synchronising pulses for the lighting systems is itself synchronised with selected shutter speed. This in turn results in a reduction of power consumption when the lights are on and for outdoor environment systems it may be preferable to maintain the power requirement to less than 10 watts while at the same time providing the requisite level of illumination.

As previously stated, the perceived output level is reduced because the camera only requires the lighting system to be on for the duration of the exposure and the lights are therefore shut off when an exposure is not taking place. The pulse width modulation system also facilitates a dimming procedure to be selected by the operation of knob 305, resulting in a reduction over which the lighting is energised, possibly changing from duration 217 to, say, duration 222.

The dimming operation is facilitated by the pulse width modulation procedure in order to maintain the colour temperature of the diodes. In a preferred embodiment, brightness is varied from full off to full on in 256 discreet steps. It is appreciated that the flicker rate is critical as strobe free or flicker free filming has to be possible at filming speeds of up to one thousand frames per second or for shutter speeds of up to one thousandth of a second, and also with shutter angles of between one hundred and forty degrees and two hundred and five degrees. It is also appreciated that the flicker free characteristic must be maintained at all dimming levels.

In a preferred embodiment, the physical dimmer control 305 operates in a single turn and is not of the infinite rotation type. By adopting this approach, it is possible for the control dimmer to be calibrated such that the physical position of the dimmer knob 305 guarantees a specific illumination level for repeatability. It is appreciated that the operatives will often take very precise exposure measurements for a scene or shot and all readings, positions and measurements that affect the set up of the shot must remain constant and repeatable.

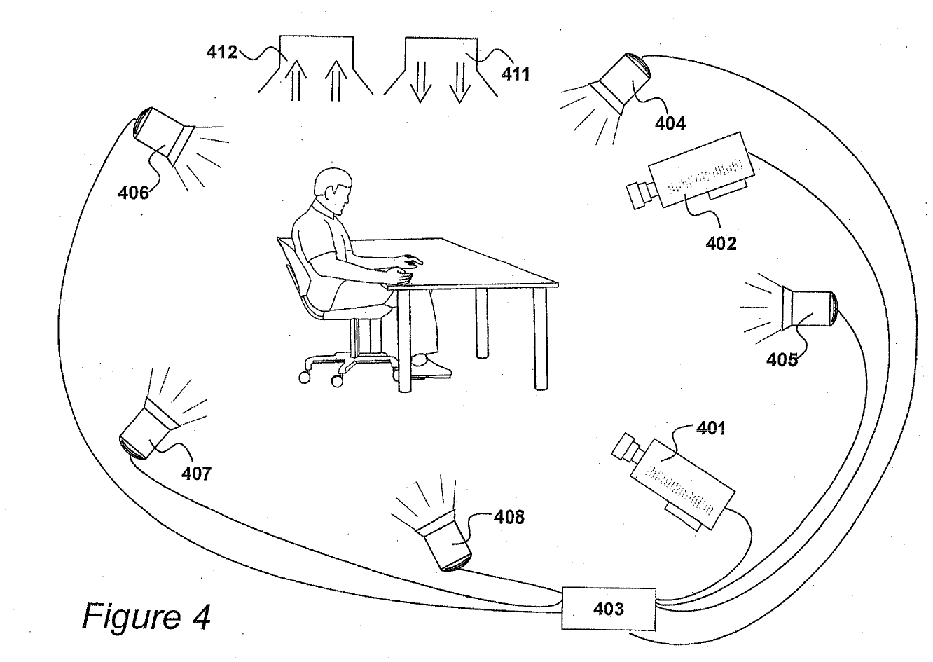

An alternative configuration is illustrated in FIG. 4, representing a studio environment. In this basic configuration, seated talent is being captured by a first video camera 401 and by a second video camera 202. Each of these cameras receives house synch from a control system 403. The control system 403 also receives synchronised video pictures from cameras 101, 102 and is responsible for supplying synchronisation pulses to front lights 404, 405, rear lighting 406 and 407 and to fill lighting 408. All of the lighting systems 404 to 408 are constructed from light emitting diodes and all are configured such that their energisation is synchronised to the camera shuttering devices such that the synchronised light sources are energised substantially during capturing portions and not energised for at least a part of an idle portion that falls within frame intervals but does not form part of the capturing portions.

In the studio environment of FIG. 4, the ambient light problem of the environment of FIG. 3 is not present. However, studio environments have problems all of their own. A particular problem with studio environments, that often include audience, is that of heat removal. In the example shown, an air conditioning system is provided to introduce cool air via a vent 411 and to remove warm air via a vent 412. Thus, in addition to the costs of energising the main studio equipment, significant additional costs are also required in terms of maintaining the operational environment at desirable temperatures. In this respect, LED systems are highly desirable. Firstly, even when energised, the LED systems produce significantly less heat than tungsten lighting systems. Furthermore, however, by deploying an embodiment of the present invention, it is possible to reduce heat output further. This in turn not only saves energy as such, further energy savings are made in that a lower demand is placed on the air conditioning system. Furthermore, the durability of the LED systems also ensures that lower demands are required in terms of studio maintenance. This is particularly important in studio environments that have long duty cycles, as is being seen to a greater extent such as on rolling news programmes and shopping channels etc. Furthermore, as the number of broadcast channels increases and there is a greater demand for increased content with lower audience figures for each channel, there is an overriding requirement to reduce the cost of programme making.

In an alternative embodiment, an array of light emitting diodes is provided of different colours such that when an energising signal energises the array individual colours may receive individual energising signals so as to allow a gamut of colours to be produced without the need for a colour filter gel.

In a further embodiment, each of the diodes produces red light, green light, blue light or white light. A colour request is specified as three co-ordinates in colour-space and these three colour co-ordinates are converted into four energising levels, with each of the light emitting diodes being energised in response to a respective one of these energising levels.

1. A method of producing a video signal from a scene lit (at least partially) by artificial light, comprising the steps of;
capturing fields or frames of video at a capture rate such that a frame interval exists that relates exclusively to an individual field or frame;
deploying a shuttering device such that light is received for a capturing portion of each frame interval; and
energising a synchronised light source to provide at least a part of the artificial light, wherein
said synchronised light source is synchronised to said shuttering device, such that the synchronised light source is energised substantially during said capturing portions and not energised for at least a part of an idle portion that falls within said frame intervals but not forming part of the capturing portions.

2. A method according to claim 1, wherein said artificial light is produced by light-emitting diodes.

3. A method according to claim 2, wherein the light-emitting diodes have a controllable output level and said output level is controlled by varying the duration of energising pulses.

4. A method according to claim 1, wherein image frames are captured at a rate of 25 or 30 frames per second or 30 frames non-drop or 30 frames drop.

5. A method according to claim 1, wherein said shuttering device forms part of a video camera.

6. A method according to claim 5, wherein said video camera produces a frame synchronisation signal and said frame synchronisation signal is used to control the energising of the light sources.

7. A method according to claim 6, wherein the light sources are physically mounted to the camera.

8. A method according to claim 1, wherein the shuttering device and the light source each receive synchronising pulses from a synchronising pulse generator.

9. A method according to claim 8, including a plurality of video cameras, wherein each of said video cameras is configured to receive said synchronising pulses.

10. A method according to claim 8, including a plurality of light sources and a plurality of light source energising devices, wherein each of said light source energising devices receives said synchronising pulses.

11. A method according to claim 1, wherein said light source is an array of light emitting diodes of differing colours such that an energising signal energises said array without requiring a mechanical shutter and individual colours receive individual energising signals so as to allow a gamut of colours to be produced without the need for a colour filter gel.

12. A method according to claim 11, wherein each of said diodes produces red light, green light, blue light or white light; a colour request is specified as three co-ordinates in colour space; said three co-ordinates are converted into four energising levels; and each of said light emitting diode colours (red, green, blue and white) is energised in response to a respective one of said energising levels.

13. Apparatus for producing a video signal from a scene lit (at least partially) by artificial light, comprising
a video capturing device (camera) for capturing video fields or frames of video at a capture rate such that a frame interval exists that relates exclusively to an individual field or frame;
said camera including a shuttering device such that light is received for capturing a portion of each frame interval; and
an energisation device is configured to energise a synchronised light source to provide at least part of the artificial light, wherein
the synchronised light source is synchronised to the shuttering device, such that the synchronised light source is energised substantially during the capturing portion and is not energised for at least a part of an idle portion that falls within the frame intervals but does not form part of the capturing portions.

14. Apparatus according to claim 13, including light emitting diodes for generating the artificial light.

15. Apparatus according to claim 14, wherein the light emitting diodes have a controllable output level and said output level is controlled by varying the duration of energising pulses.

16. Apparatus according to claim 13, wherein said shuttering device forms part of a video camera.

17. Apparatus according to claim according to claim 16, wherein said video camera produces a frame synchronisation signal and said frame synchronisation signal is used to control the energising of the light sources.

18. Apparatus according to claim 17, wherein said light sources are physically mounted to the video camera.

19. In a recording studio, apparatus for producing video signals from a scene lit by artificial light, comprising
a video camera for capturing video fields or frames of video at a capture rate such that a frame interval exists that relates exclusively to an individual field or frame;
said camera including a shuttering device such that light is received for capturing a portion of each frame interval; and
an energisation device configured to energise synchronised light emitting diodes to provide said artificial light, wherein
the synchronised light is synchronised with the shuttering device, such that the synchronised light emitting diodes are energised during the whole of said capturing portion and are not energised for at least a part of an idle portion that falls within the frame intervals but does not form part of the capturing portions.

20. Apparatus according to claim 19, wherein a plurality of video cameras and a plurality of LED light sources each receive synchronising pulses from a synchronising pulse generator.
